(19) United States
(12) Patent Application Publication
(10) Pub. No.: US 2009/0006148 A1
(43) Pub. Date: Jan. 1, 2009

(54) APPARATUS AND METHOD FOR MATERIALIZING RELATED BUSINESS INTELLIGENCE DATA ENTITIES

(75) Inventors: Krzysztof BACALSKI, London (GB); David Malcolm COLLIE, Surrey (GB)

Correspondence Address: COOLEY GODWARD KRONISH LLP;ATTN: Patent Group, Suite 1100, 777 - 6th Street, NW, Washington, DC, 20001, US

(73) Assignee: BUSINESS OBJECTS, S.A., Levallois-Perret (FR)

(21) Appl. No.: 11/769,375

(22) Filed: Jun. 27, 2007

(51) Int. Cl. G06F 17/50

(52) U.S. Cl. 705/7

(57) ABSTRACT

A computer readable storage medium includes executable instructions to retrieve a set of result values associated with a query to a data source. The set of result values are processed into an intermediate data entity, where the executable instructions to retrieve and process materialize the intermediate data entity. Metadata is included in the intermediate data entity to facilitate the use of the intermediate data entity in a future materialization, where the metadata is exposed through an interface to a materialization engine. The intermediate data entity is stored in a secondary data source. The secondary data source is made available to one or more consumers so that the intermediate data entity is used to define another intermediate data entity.

### BRIEF DESCRIPTION OF THE INVENTION

This invention relates generally to information processing. More particularly, this invention relates to retrieving and processing information from data sources.

### BACKGROUND OF THE INVENTION

Business Intelligence (BI) generally refers to software tools used to improve decision-making. These tools are commonly applied to financial, human resource, marketing, sales, customer and supplier analyses. More specifically, these tools can include: reporting and analysis tools to present information, content delivery infrastructure systems for delivery and management of reports and analytics, data warehousing systems for cleansing and consolidating information from disparate sources, and data management systems to collect, store, and manage raw data.

Common operations in a BI system are querying and filtering of data in a data source by read only processes. Query tools include ad hoc query tools. An ad hoc query is created to obtain information as the need arises. There are a number of commercially available products to aid a user in the definition and applications of filters. There are set definition tools that accept a user's logical conditions for the set and convert them into one or more queries for a data source. For instance, Business Objects, sells set definition and creation products, including BusinessObjects Set Analysis XI™. As used herein, the term set refers to a segment of a data set defined by one or more conditions. Conditions include those based on data, metadata, formulas, parameters and other sets. The conditional definition of sets allows sets to be defined without knowing the items that make up the set but knowing what aspects the items collectively share. The sets can be static or dynamic. For dynamic sets the parameters in the conditions vary with time. The parameters for static sets do not.

The definition of a set of results and the creation, or materialization, of the set of results are two different acts. She definition of a set of results is abstract (e.g., it is done in a declarative way). That is a set can be defined without retrieving the set of result values. However, because a set can be defined in relation to another set or a filter value some data from the data source can be included in the set definition. Once materialized, the data can be consumed or stored in a secondary data source. Materialization includes data source query and data processing operations. In the case of a set as an intermediate data entity, the set often is defined with respect to one or more sets. Therefore, many sets may need to be materialized to create one set. Therefore, sets need to be efficiently materialized. Efficient set materialization is also useful for when a set needs to be automatically refreshed.

Materialization is not limited to sets. The materialization process and materialization strategies are applicable to various BI content entities including: OLAP cubes, data marts, performance management entities, analytics, and the like. Performance management tools are used to calculate and aggregate metrics, give key performance indicators and scorecards, perform analyses, and the like. They are used to track and analyze metrics and goals via management dashboards, scorecards, analytics, and alerting. Some performance management tools, such as those including data and results in OLAP cubes, are useful for “what if” analyses.

In view of the above, it is desirable to provide improved techniques for materializing data. It would also be desirable to enhance existing BI tools to facilitate improved materialization techniques.

### SUMMARY OF INVENTION

The invention includes a computer readable storage medium with executable instructions to retrieve a set of result values associated with a query to a data source. The set of result values are processed into an intermediate data entity, where the executable instructions to retrieve and process materialize the intermediate data entity. Metadata is included in the intermediate data entity to facilitate the use of the intermediate data entity in a future materialization, where the metadata is exposed through an interface to a materialization engine. The intermediate data entity is stored in a secondary data source. The secondary data source is made available to one or more consumers so that the intermediate data entity is used to define another intermediate data entity.

The invention also includes a computer readable storage medium with executable instructions to receive a new declarative materialization request for a new intermediate data entity. The new declarative materialization request is compared to an old declarative materialization request, where the old declarative materialization request is stored in a first node. The new declarative materialization request is redefined to reflect redundancy with the old declarative materialization request. The new declarative materialization request is stored in a second node. The first node is linked to the second node.

An embodiment of the invention includes a computer readable storage medium with executable instructions defining a first node representing a materialization request, where the materialization request includes a first query and a location of a data source. A second node represents an intermediate data entity, where the second node includes a second query used to define the intermediate data entity, and a set of metadata describing the intermediate data entity. An edge couples the first node and the second node, thereby forming a graph including the first node, the second node and the edge, where the graph represents a materialization request system.

### BRIEF DESCRIPTION OF THE FIGURES

The invention is more fully appreciated in connection with the following detailed description taken in conjunction with the accompanying drawings, in which:

FIG. 1 illustrates a computer constructed in accordance with an embodiment of the invention.

FIG. 2 illustrates an architecture diagram showing components of a materialization system in accordance with an embodiment of the invention.

FIG. 3 illustrates processing operations for materializing data associated with an embodiment of the invention.

FIG. 4 illustrates processing operations for adding materialization requests to a queue associated with an embodiment of the invention.

FIG. 5 illustrates processing operations for processing a materialization request in a queue associated with an embodiment of the invention.

FIGS. 6A and 6B illustrate directed acyclic graphs associated with an embodiment of the invention.

FIGS. 7A, 7B, 7C and 7D show an example of a graph of materialization requests being converted into a graph of materialized intermediate data entities in accordance with an embodiment of the invention.

FIG. 8 illustrates the contents of a node from the graphs in FIGS. 6 and 7 in accordance with an embodiment of the invention.

Like reference numerals refer to corresponding parts throughout the several views of the drawings.

### DETAILED DESCRIPTION OF THE INVENTION

The following terminology is used while disclosing embodiments of the invention:

A data source is an information resource. Data sources include sources of data that enable data storage and retrieval. Data sources may include databases, such as, relational, transactional, hierarchical, multidimensional (e.g., OLAP), object oriented databases, and the like. Further data sources may include tabular data (e.g., spreadsheets, delimited text files), data tagged with a markup language (e.g., XML data), transactional data, unstructured data (e.g. text files, screen scrapings), hierarchical data (e.g. data in a file system, XML data), files, a plurality of reports, and any other data source accessible through an established protocol, such as, Open DataBase Connectivity (ODBC) and the like. Data sources may also include a data source where the data is not stored like data streams, broadcast data, and the like.

An Intermediate Data Entity (IDE) is a set of data. An intermediate data entity is obtained from a data source and is stored at an intermediate level between the data source and the data consumer. An intermediate data entity includes a results set from a data source optionally with metadata added. An intermediate data entity can be defined by which calculations were applied to the data in the data source or can be a subset of data from the data source. Examples of intermediate data entities include sets, OLAP cubes, data marts, performance management entities, analytics, and the like.

Materialization is the act of retrieving or calculating a results set. Materialization includes creating a results set from data in one or more data sources. The definition of the results set is used to specify the contents of the set while a materialization engine determines how it is materialized. A results set can be stored as an intermediate data entity.

A set is a collection of data. A set can be thought of as a collection of distinct items. A set is a collection partitioned from the set of all items (i.e., a universe) in accordance with one or more conditions. Conditions include those based on geography, time, product, customers, and the like. The conditional definition of sets allows sets to be defined without knowing the items that make up the set but knowing what features the items collectively share. In this way, a set's definition is declarative. Sets can be static or dynamic. Sets can be automatically refreshed with the latest member information.

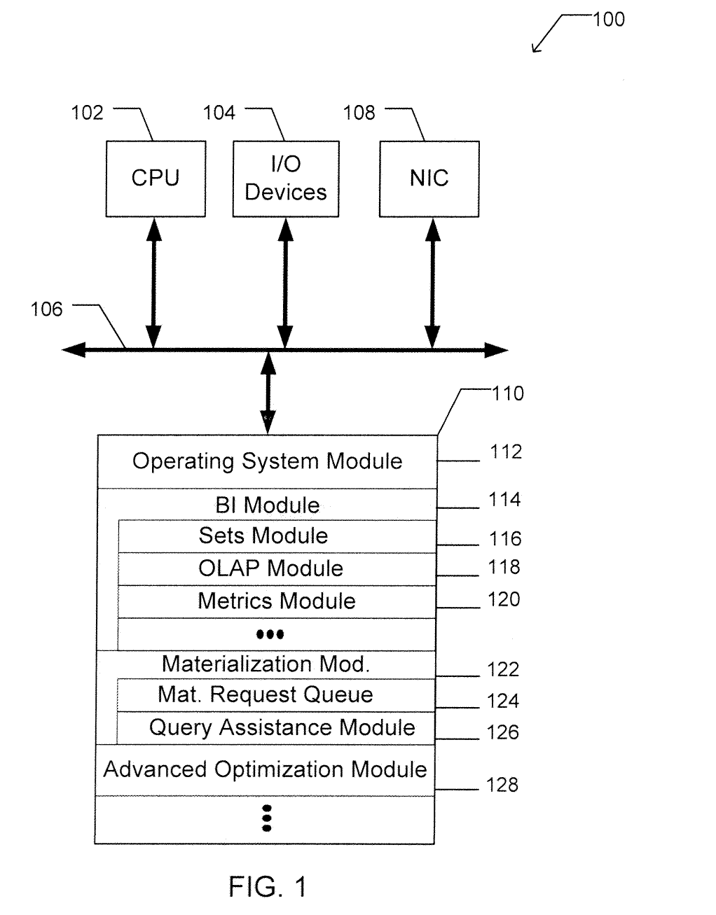

FIG. 1 illustrates a computer 100 configured in accordance with an embodiment of the invention. The computer 100 includes standard components, including a central processing unit 102 and input/output devices 104, which are linked by a bus 106. The input/output devices 104 may include a keyboard, mouse, touch screen, monitor, printer, and the like. A network interface circuit 108 is also connected to the bus 106. The network interface circuit (NIC) 108 provides connectivity to a network (not shown), thereby allowing the computer 100 to operate in a networked environment. In an embodiment, two or more data sources (not shown) are coupled to computer 100 via NIC 108.

A memory 110 is also connected to the bus 106. In an embodiment, the memory 110 stores one or more of the following modules: an operating system module 112, a business intelligence (BI) module 114, a sets module 116, an OLAP module 118, a metrics module 120, a materialization module 122, a materialization request queue 124, a query assistance module 126 and an optimization module 128. The operating system module 112 may include instructions for handling various system services, such as file services or for performing hardware dependant tasks.

The BI module 114 includes executable instructions to perform BI related functions on computer 100 or across a wider network, BI related functions include generating reports, performing queries, performing analyses, and the like. The BI module 114 can include one or more sub-modules selected from the sets module 116, OLAP module 118, metrics module 120 and the like. The metrics module is for calculating and aggregating metrics. The OLAP module supports designing, generating, and viewing OLAP cubes, as well as related activities. The sets module 116 includes executable instructions for defining sets and requesting these sets be materialized by interfacing with the materialization module 122.

The materialization module 122 includes executable instructions to materialize data in response to materialization requests. The module 122 also includes executable instructions to manage the materialization request queue 124 and processing agents defined by executable instructions in the BI module 114. The query assistance module 126 processes queries made by other executable instruction including those in the BI Module 114 and its sub-modules. These queries can be placed in the materialization request queue 124. The materialization module 122 may include executable instructions to call executable functions in the optimization module 128 to assist in the management of the queue.

The materialization request queue 124 stores pending requests for results sets or intermediate data entities. These requests are called materialization requests. The requests can be arranged as individual discrete requests, in a system of requests or both. A system of requests is a plurality of requests arranged as a graph where each request is a node. The edges in the graph account for the dependencies between requests. Embodiments of the invention, extend this linking from requests to previously materialized intermediate data entities. In this way the burden of materializing a result set is lessened by using a previous materialized result set as the desired results set, part of the desired results set, or part of the specification to the desired results set. The materialization request queue 124 will be sorted by executable instructions in the materialization module 122 or the optimization module 128.

The executable modules stored in memory 110 are exemplary. Other modules could be added, such as, a graphical user interface module. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

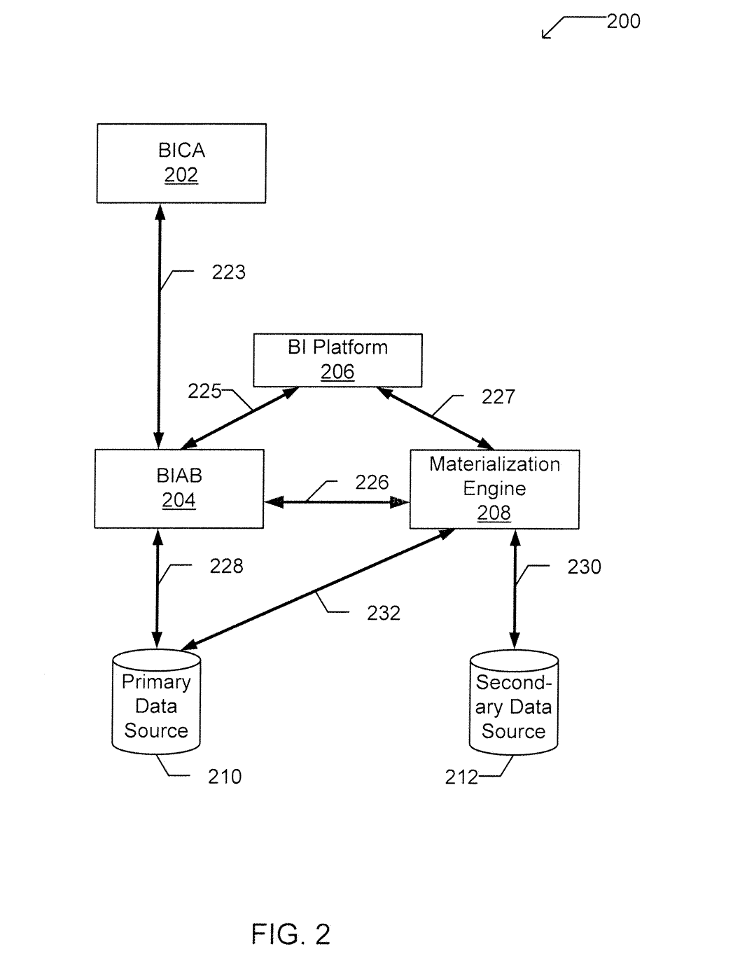

FIG. 2 illustrates an architecture diagram showing components of a BI-materialization system in accordance with an embodiment of the invention. The BI-materialization system 200 includes components designed to cooperate to provide business intelligence and materialization services. A BI Client Application (BICA) 202 is defined by executable instructions in the BI module 114 or one of its sub-modules. e.g., metrics module 120. The BICA 202 is coupled to a BI Application Backend (BIAB) 204. The BIAB 204 is also defined by code in the BI module 114 or one of its sub-modules. The BLAB is disposed between a BI platform 206, a materialization engine 208 and primary data source 211. The BI platform 206 is defined by the BI module 114. The materialization engine 208 is defined by executable instructions and data in the materialization module 122 and includes the request queue 124. The primary data source 210 is a data source that a business intelligence application backend of the prior art would have used. A secondary data source 212 is coupled to the materialization engine 208. The secondary data source 212 stores materialized intermediate data entities.

The BICA 202 and the BIAB 204 interact in a frontend backend relationship 223. The BI platform 206 provides services via channel 225 to the BIAB 204. The BIAB 204 interacts along channel 226 with the materialization engine 208. The BI platform 206 may control the materialization engine 208 by providing a scheduling service or incorporating the engine's service into the services the BI platform 206 provides. The BI platform 206 and materialization engine 208 communicate via channel 227. The materialization engine 208 analyses queries generated in the BIAB 204 using executable instructions in the query assistance module 126. Some high priority queries from the BIAB 204 are executed immediately while the balance are diverted to materialization system. These queries are stored in the request queue 124 within the materialization engine 208. The materialization engine 208 selects requests from the queue and processes them. The engine then directs the BIAB 204 as an agent acting on its behalf to launch queries against the primary data source 210 via channel 228. The materialization engine 208 writes the result sets of these queries to the secondary data source 212 via read-write channel 230. The secondary data source stores intermediate data entities.

In BI-materialization system 200 the materialization engine 208 controls which results sets are materialized. The engine 208 can optimize the materialization requests by processing its queue and/or using the previous materialized results sets in the intermediate data entities stored in the secondary data source 212. For example, if a request for a set of metrics is selected from the request queue 124, then, the engine 208 calls on the BLAB 204 running executable instructions from metrics module 120. The executable instructions calculate and aggregate metrics from data queries from the primary data source. The BIAB 204 can call on another executable instructions for further operations, e.g., call the OLAP module 118 to create a cube populated with the metrics. After the results set is materialized it is written to the secondary data source 212—e.g. write a performance management cube to the data source 212 as an intermediate data entity. The materialization engine 208 orchestrates the life cycle of one or more intermediate data entities. These are written to a data source, i.e., the secondary data source, as a feedback loop and made available for future use.

There are various alternative embodiments to the BI-Materialization system 200 shown in FIG. 2. The details of the relationship 223 differ with the specific architecture of a specific example of system 200. In an embodiment, the BICA 202 and the BLAB 204 are combined into one component. In an embodiment the materialization engine 208 queries the primary data source itself via stream 232. The materialization engine 208 can have two or more agents like BIAB 204—not shown.

A BI-Materialization system such as system 200 enables useful workflows and practices with a BI system. Lower priority materialization requests can be diverted from the BIAB 204 and be processed by the materialization engine 208. The materializations can be processed in a queue or scheduled by the BI platform 206. For example, a materialization request may need to run at a certain time. BI-Materialization system with the materialization engine 208 is designed to transparently (to the end-user) improve the materialization process.

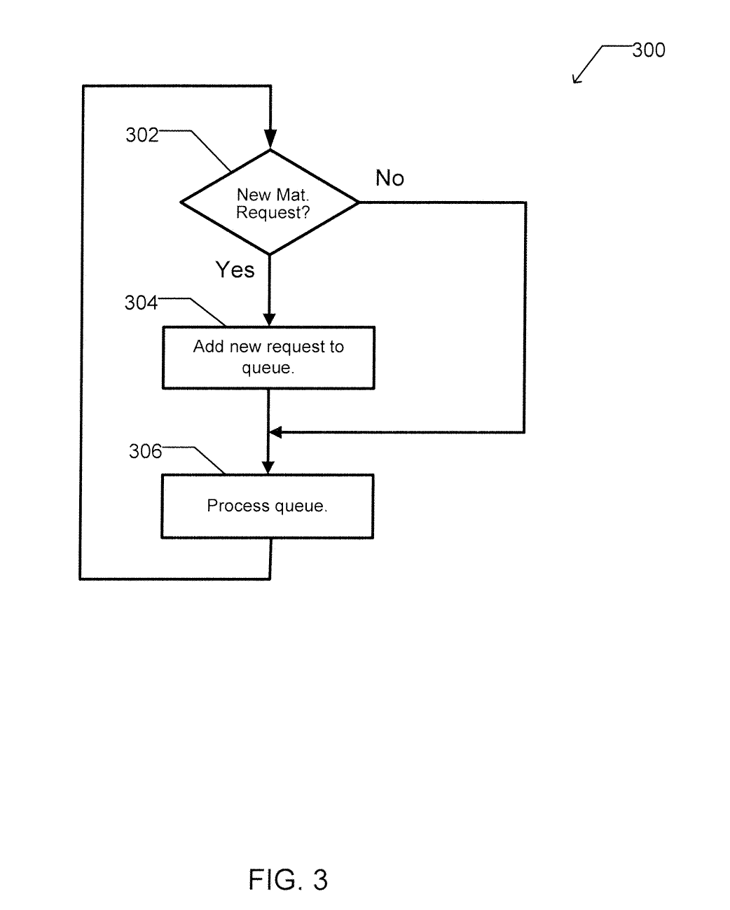

FIG. 3 illustrates a high level set of processing operations within a loop 300 associated with an embodiment of the invention. The materialization module 122 tests for the receipt of one or more materialization requests 302. If 302-Yes, the materialization request or requests are added to a materialization request queue 304. These requests are pre-processed while being added to the queue. Processing continues with processing of the queue at 306. If 302-No, processing continues of the materialization requests in the materialization request queue 306.

In business intelligence systems materialization requests are continually arriving. The demand for resource can exceed capacity over limited time scales. Hence, a queue is needed. To realize low latency the queue (i.e. request queue 124) needs to be managed and optimized. This includes developing a materialization strategy for the requests in the queue. The executable instructions in the materialization module 122 can call upon the optimization module 128 to assist in this. Because requests are always arriving, the main process has to continually check for new requests hence operations 302 and 304 occur in a loop with the processing operation 306. The management of the queue includes managing declaratively defined materialization requests which can be interpreted by computer 100 and if need be redefined to improve system performance. Embodiments of the invention are suitable for use in materializing sets as sets are often defined in relation to other sets.

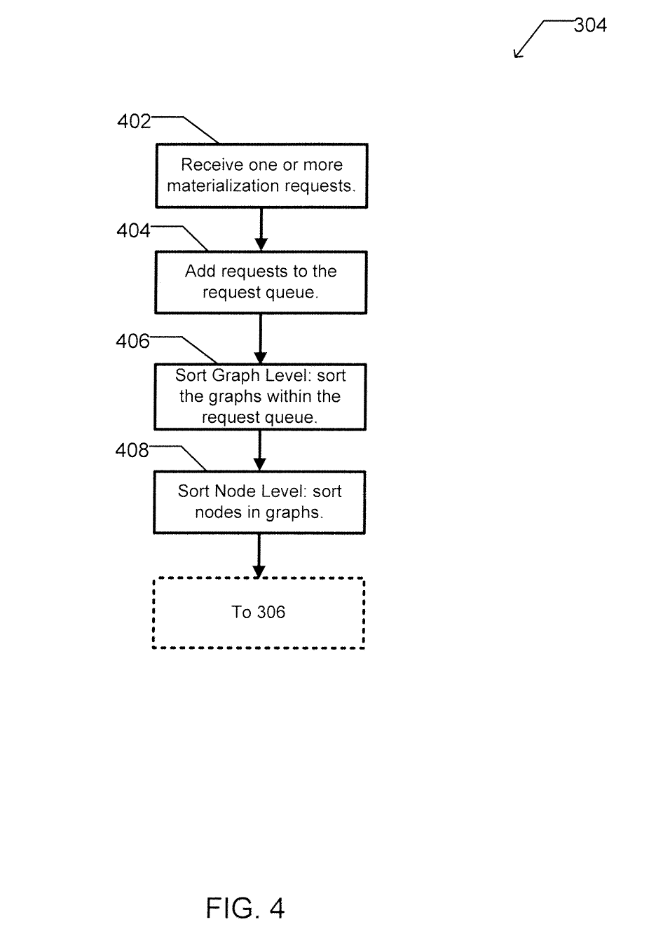

FIG. 4 illustrates a set of processing sub-operations within the processing operation 304. The materialization engine 208 receives one or more requests for intermediate data entities 402. Applying preprocessing these requests are added to a request queue 404. The preprocessing includes searching the queue for duplicate requests. Processing also includes, identifying sub-requests, super-requests or both to the new requests. Processing also includes locating similar requests. These new requests are added to graphs that define systems of related requests. The request queue is structured as one or more directed acyclic graphs. The graphs are directed to show dependency and acyclic because the dependencies are never self referential. Each request can be defined as one or more nodes in the graph. The graph can also contain previously materialized intermediate data entities.

In an embodiment, the queue is sorted 406. This is a graph level sort. That is the position of each graph in the queue is assessed relative to each other graph. The sorting of graphs reflects the priority logic of the queue. The priority logic can include sorting graphs by time in the queue, expected duration to materialize requests, impact of materialization and the like. A materialization request's impact is a measure based on the difference between the resources consumed to materialize a collection of requests without treating them as a system and those consumed to materialize the same collection of requests when treating the collection as a system. The nodes in a first graph and optionally more graphs are sorted 408. This is a node level sort where the nodes in the graph are sorted into a desirable order.

The managing of the request queue 124 in FIG. 4 depends on treating each materialization request as actually or potentially part of a system of requests. The executable instructions in the materialization module 122 then can holistically optimize the queue per processing operations 404-408. The optimization of the queue has three aspects: systems of requests are mutable, the content of each system needs to be known, and each system needs to be appropriately sorted. Each request can be added to a system or removed to optimize the queue. Graphs can be augmented, trimmed, merged or broken apart. Hence the systems of requests in queue 124 are mutable. The content of each system is defined by a graph. The boundaries of each graph need to be known for operations 406 and 408. This can be accomplished by computing the transitive closure of a graph. One suitable algorithm for this is the Floyd-Warshall algorithm which runs in cubic time for the number of nodes. The third aspect, sorting (also called ordering) of requests within a graph, is affected by the first two aspects.

A computational problem similar to optimizing materialization requests is the scheduling of a series of related tasks. The series is represented in a graph. The tasks are nodes, and there is an edge from a first task to a second task if the first must be completed before the second. Traditionally, these edges are treated as being immutable. This is a classic application for topological sorting. A topological sort gives an order to perform the tasks. However, the strict and static application of topological sorting on its own is inappropriate for optimization of materialization requests. The graph that defines a set of materialization requests is constructed to reflect a given materialization strategy in light of a series of requests. As the requests are made, one or more graphs are constructed; each is mutable. The graph that defines a system of materialization requests is mutable. Hence, the need to re-sort arises. However, topological sorting can be suitable for some embodiments.

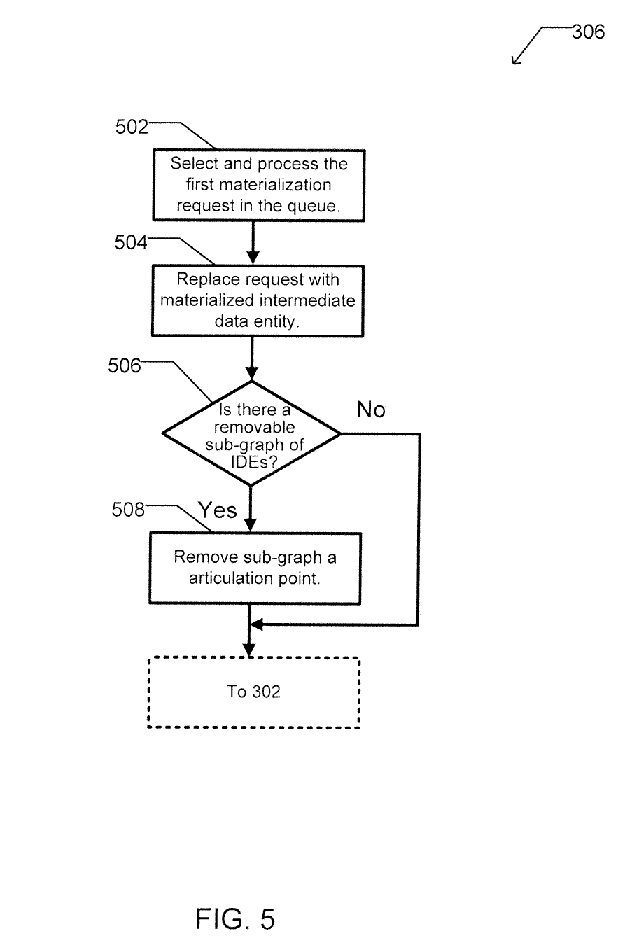

FIG. 5 illustrates a set of sub-operations within the processing operation 306. A materialization request is selected from the request queue and processed 502. The results set to that materialization request, usually an intermediate data entity, now replaces the materialization request in any graph the request was part of 504. Any edges incident upon the node with the newly created intermediate data entity are updated to show that the edge is frangible. However, the edge is only updated if it does not serve as a link in a chain of materialization requests and/or intermediate data entities. Next, the instructions in the materialization module 122 test to determine if the recently added intermediate data entity is part of a removable sub-graph within the graph 506. A removable sub-graph is a collection of nodes that are not on a dependency chain and are interconnected by frangible edges. If 506-Yes, the sub-graph is removed 508. If 506-No, processing continues at processing operation 302.

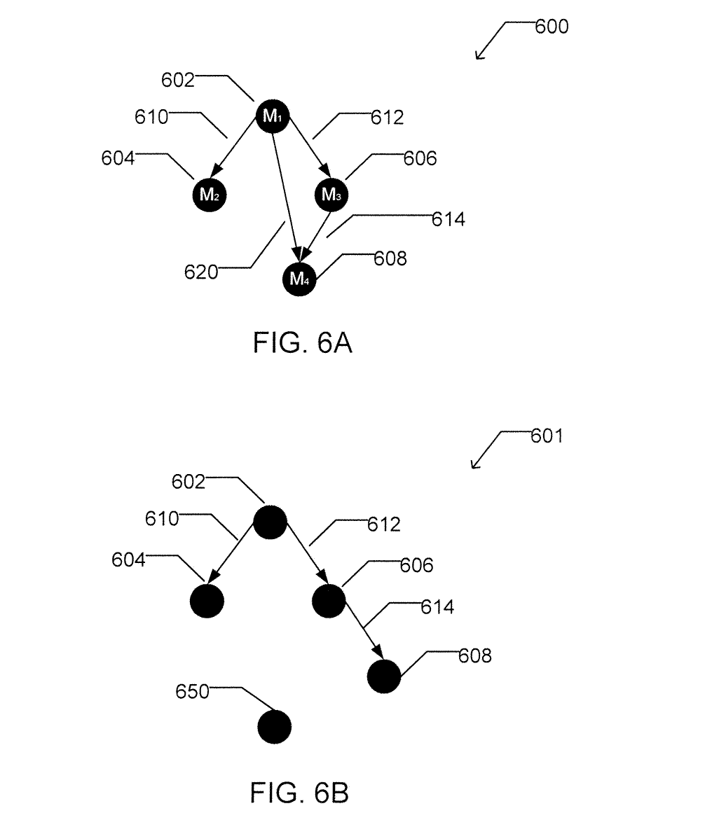

Some embodiment of the invention use graphs. A graph is a visual scheme that depicts relationships. It is also a data structure. FIG. 6A illustrates a type of graph commonly referred to as a directed acyclic graph 600. A graph may be defined by its nodes (e.g., 602, 604, 606, and 608, collectively denoted A and its edges e.g., 610, 612, 614, and 620, collectively denoted E). A graph G is then defined as G=(V, E). An individual node is labeled by its name and an individual edge is labeled by its name, e.g., 620, or the nodes at its termini, e.g., (604, 608). Graph 600 is a directed graph because the edges are defined with a direction. For example, edge (602, 606) is not the same as edge (606, 602). This can be denoted with arrows for edges as shown. The graph 600 is acyclic since no traversal (along the direction indicated by arrows) of the graph returns to the starting point.

FIG. 6B illustrates two other graphs. Graph 601 is a special case of a directed acyclic graph called a tree. A node at the beginning of a directed edge is a parent, and the node at the end is a child. In a tree there is one node with no parent and the remaining nodes have only one parent. Graph 601 differs from graph 600 by the absence of an edge. i.e., 620. The other graph shown in FIG. 6B is a special case of a directed acyclic graph—a single node graph 650.

In accordance with embodiments of the present invention, the materialization module 122 stores and manipulates graphs. These graphs can be part of the request queue 124. The graphs are used to define the dependencies of materialization requests on other materialization requests and previously materialized intermediate data entities. For example, in graph 600 there are four materialization request-intermediate data entities:

M1, the materialization request or intermediate data entity of node 602;

M2, the materialization request or intermediate data entity of node 604;

M3, the materialization request or intermediate data entity of node 606; and

M4, the materialization request or intermediate data entity of node 608.

M2 depends on M1, M3 depends on M1 and M4 depends on M1 and M3. If there are three materialization requests, one to materialize each of M2, M3 and M4 and materialization were processed in isolation, then there would be redundancy. The following work would be performed: materialization of M1, M1 then M2, M1 then M3, and M1 then M3 then M4. Obviously this is inefficient because some nodes are necessarily processed multiple times, e.g., M1×4. M3×2. In some implementations, an individual materialization may take many hours.

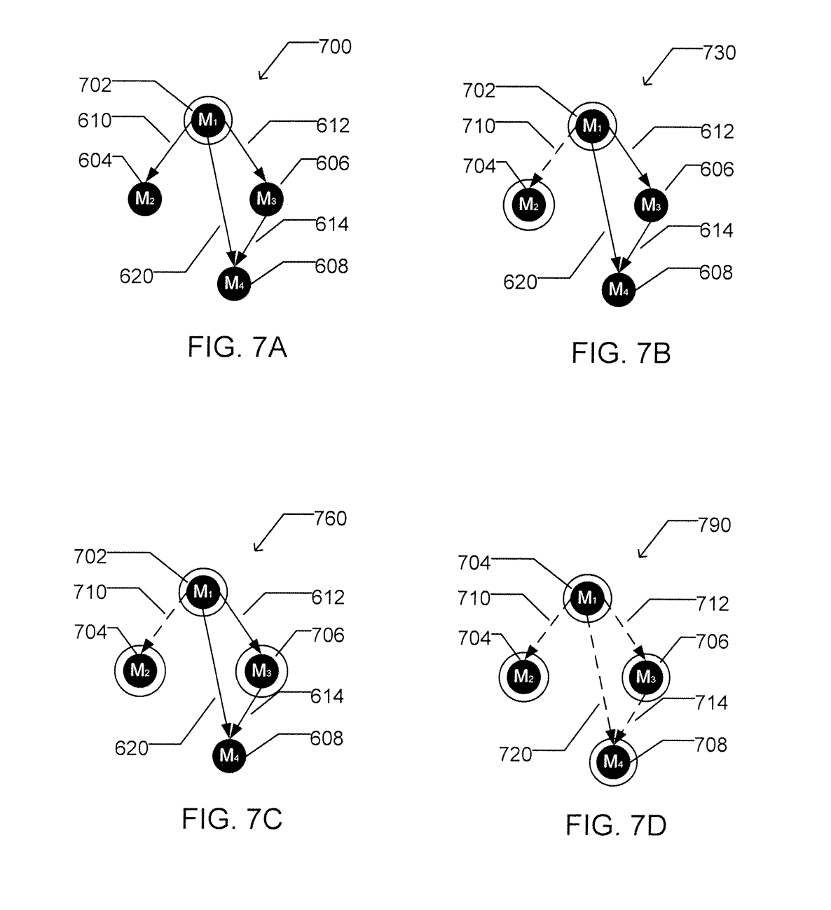

FIG. 7 shows a graph of dependent materialization requests being converted into a graph of materialized intermediate data entities. In an embodiment, a set of requests are coalesced into a graph in a request queue. The request queue is evaluated to determine an efficient processing route. For the above example, the materializations are performed as follows: M1, M2, M3 and M4. That is, the graph containing the materialization requests is sorted into that order.

The initial state is shown as graph 600 of FIG. 6. In graph 700 of FIG. 7A the first request has been materialized into intermediate data entity 702. Herein, a materialized intermediate data entity is represented by a node enclosed in a circle. In FIG. 7B the second request has been materialized into intermediate data entity 704 and reinserted into graph 730. According to processing operation 504, the incoming edge to entity 704 has been replaced with a frangible edge 710. In FIG. 7C the third request M3 has been materialized into intermediate data entity 706. This is reinserted into graph 760. However, edge 612 remains because M4 depends on M3, which depends on M1. Hence, it would not be computationally advantageous to remove M1 from the graph. Finally, in FIG. 7D the fourth request M3 has been materialized into intermediate data entity 708. This is reinserted into graph 790 with a frangible edge 714. A frangible edge 712 is also added. Assuming that graph 790 was part of a larger graph it would be a suitable sub-graph to remove from the processing queue.

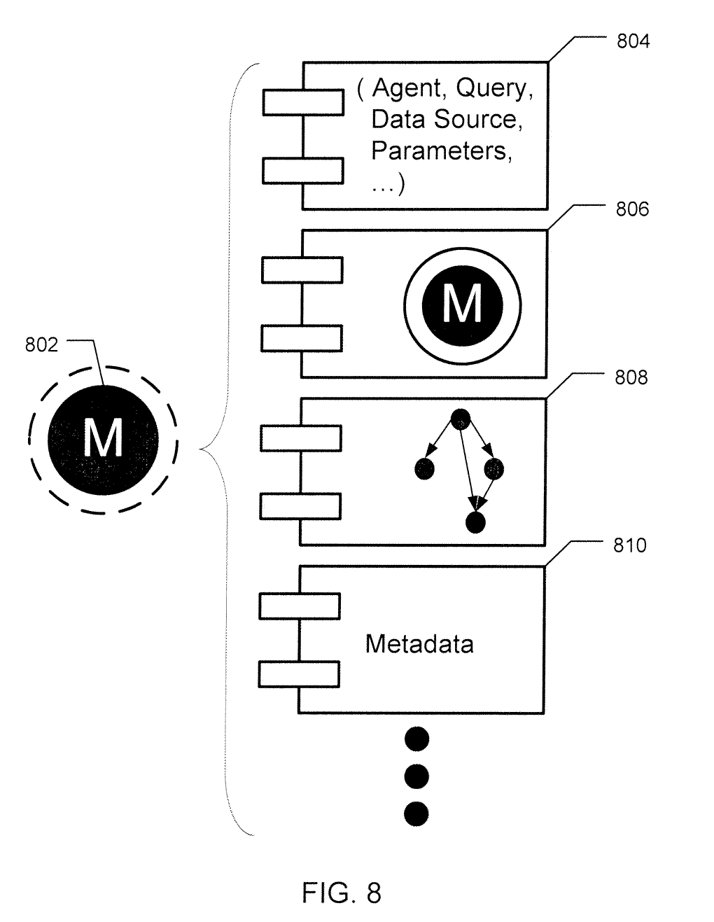

FIG. 8 illustrates the contents of a node for graphs used in accordance with an embodiment of the invention. Nodes like node 802 are used in the request queue 124 and the graphs shown in FIGS. 6 and 7. The node 802 includes data and metadata used by BI-Materialization system 200 and especially the materialization engine 208. The node 802 can contain either a request for an intermediate data entity, or a request and an intermediate data entity. Hence it is shown encircled by a dotted line.

The node 802 comprises a materialization request 804. The materialization request 804 includes a specification of an agent (e.g., BIAB 204), a query statement, a data source, a set of parameters and the like. The query statement is one or more queries to the data source. The queries are used by the agent to retrieve data from the data source. The materialization engine 208 uses the queries to manage the request 802 and any resulting intermediate data entity.

The node 802 further comprises an intermediate data entity or a link thereto 806. Because the node 802 is a way to manage an intermediate data entity, or request therefore, it does not matter if the intermediate data entity is located within node 802 or simply includes a link to it. Therefore, without lose of generality, both cases are covered when node 802 is said to include an intermediate data entity 806. The intermediate data entity 806 has been materialized in response to a materialization request—e.g., 804. In this way, the request 804 is metadata to the intermediate data entity 806. The request 804 as metadata is useful when the intermediate data entity is a set. The request 804 then describes the set without a need to state each item in the set.

Also included in node 802 is a set of graph structure information 808. The graph structure information 808 includes the ability to track incident and outgoing edges from node 802. This describes how node 802 is connected to other nodes containing materialization requests or intermediate data entities.

Additional metadata 810 is also included in node 802. This additional metadata 820 can include graph search information or graph sort information. For example, the nodes of a graph can be colored to facilitate various graph algorithms. Colorings of nodes can be applied or consumed by executable instructions in the advanced optimization module 128. A useful graph algorithm for use on a graph in the present invention is breadth first search. The metadata 810 can include information on a materialized intermediate data entity 806, for example, the type of intermediate data entity, the resources consumed to create the entity and the like. The actual or estimated execution time of a materialization request can be included in metadata 810. The estimated time can be calculated from previous execution times. The metadata 810 can include graph processing information, such as, which nodes are removable and which nodes are articulation points between subgraphs. The metadata 810 can include scheduling information to assist a scheduling engine (e.g., BI Platform 206) in scheduling processing operations to service materialization requests. Additional information in metadata 810 can include data lineage information for intermediate data entities and data impact information for materialization requests.

Herein, when introducing elements of embodiments of the invention the articles “a”, “an”, “the” and “said” are intended to mean that there are one or more of the elements. The terms “comprising”, “including” and “having” are intended to be inclusive and to mean that there may be additional elements other than the listed elements.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
retrieve a set of result values associated with a query to a data source;
process the set of result values into an intermediate data entity, wherein the executable instructions to retrieve and process materialize the intermediate data entity;
include metadata in the intermediate data entity to facilitate the use of the intermediate data entity in a future materialization, wherein the metadata is exposed through an interface to a materialization engine;
store the intermediate data entity in a secondary data source; and
make the secondary data source available to one or more consumers, so that the intermediate data entity is used to define another intermediate data entity.

2. The computer readable storage medium of claim 1 wherein the metadata includes a request which was serviced to create the intermediate data entity.

3. The computer readable storage medium of claim 2 wherein the request includes one or more pieces of metadata selected from:
a data source;
a query to the data source;
a business intelligence application to launch the query;
a set of operations specifying how the set of result values is processed into the intermediate data entity; and
an entity type for the intermediate data entity.

4. The computer readable storage medium of claim 1 wherein the metadata includes graph structure information for a graph that includes the intermediate data entity.

5. The computer readable storage medium of claim 1 further comprising executable instructions to from a definition of a second intermediate data entity, wherein the definition includes the intermediate data entity.

6. The computer readable storage medium of claim 1 further comprising executable instructions to use the metadata to reuse data in the intermediate data entity.

7. The computer readable storage medium of claim 1 further comprising executable instructions to include the intermediate data entity within a system of intermediate data entities defined by a graph.

8. The computer readable storage medium of claim 1 further comprising executable instructions to specify:
the query to the data source;
a business intelligence application to launch the query; and
a set of operations by which the set of result values is processed into the intermediate data entity by the business intelligence application and materialization engine.

9. The computer readable storage medium of claim 7 wherein the executable instructions to retrieve the set of result values for the query and the executable instructions to process the results set into the intermediate data entity are executed in accordance with a schedule.

10. The computer readable storage medium of claim 7 wherein the intermediate data entity is a set.

11. The computer readable storage medium of claim 7 wherein the intermediate data entity is a cube including a set of metrics.

12. A computer readable storage medium, comprising executable instructions to:
receive a new declarative materialization request for a new intermediate data entity;
compare the new declarative materialization request to an old declarative materialization request, wherein the old declarative materialization request is stored in a first node;
redefine the new declarative materialization request to reflect redundancy with the old declarative materialization request;
store the new declarative materialization request in a second node; and
link the first node to the second node.

13. The computer readable storage medium of claim 12 wherein the old declarative materialization request is metadata to a previously materialized intermediate data entity.

14. The computer readable storage medium of claim 12 wherein the old declarative materialization request is a request for a non-materialized intermediate data entity.

15. The computer readable storage medium of claim 12, wherein the new declarative materialization request is stored in a request queue, and further comprising executable instructions to process the request queue to define an execution order of the request queue.

16. The computer readable storage medium of claim 12 wherein the new declarative materialization request encompasses the old declarative materialization request.

17. The computer readable storage medium of claim 12 wherein the new declarative materialization request is a sub-request of the old declarative materialization request.

18. A computer readable storage medium, comprising executable instructions defining:
a first node representing a materialization request, wherein the materialization request includes:
a first query, and
a location of a data source;
a second node representing an intermediate data entity, wherein the second node includes:
a second query used to define the intermediate data entity, and
a set of metadata describing the intermediate data entity; and
an edge coupling the first node and the second node, thereby forming a graph including the first node, the second node and the edge, wherein the graph represents a materialization request system.

19. The computer readable storage medium of claim 18 wherein the materialization request further includes an agent to service the materialization request.

20. The computer readable storage medium of claim 18 further comprising executable instructions to:
receive a second materialization request; and
add a third node representing the second materialization request to the graph by a second edge.

21. The computer readable storage medium of claim 18 further comprising executable instructions to merge into the graph a second graph, wherein the second graph includes a fourth node.

22. The computer readable storage medium of claim 18 further comprising executable instructions to sort the nodes of the graph.

23. The computer readable storage medium of claim 18 wherein the graph is included in a request queue and further comprising executable instructions to sort the request queue.

24. The computer readable storage medium of claim 18 further comprising executable instructions to process the materialization request.

25. The computer readable storage medium of claim 24 further comprising executable instructions to define a materialization engine that calls a business intelligence application to launch the first query against the data source.
